(19) United States
(12) Patent Application Publication
(10) Pub. No.: US 2004/0039841 A1
(43) Pub. Date: Feb. 26, 2004

(54) Methods for associating addresses in a wireless system with scalable adaptive modulation ("SAM")

(76) Inventors: Robert D. Logalbo, Hoffman Estates, IL (US); Alan P. Conrad, St. Charles, IL (US); Vidya Narayanan, Schaumburg, IL (US)

Correspondence Address: MOTOROLA, INC., 1303 EAST ALGONQUIN ROAD, IL01/3RD, SCHAUMBURG, IL, 60196

(21) Appl. No.: 10/225,981

(22) Filed: Aug. 22, 2002

(51) Int. Cl. G06F 15/16

(52) U.S. Cl. 709/245; 709/236

(57) ABSTRACT

An inbound message is received over a scalable adaptive modulation (“SAM”) interface (104). The inbound message comprises a SAM layer 2 (“L2”) header and data in which the SAM L2 header encapsulates. A hardware L2 address is identified for the first device from the encapsulated data and a SAM L2 address is identified for the second device from the SAM L2 header. Once both addresses are identified, an association between the hardware L2 address of the first device and the SAM L2 address of the second device is stored. Similarly, the association may be made between the hardware L2 address of the first device and the SAM L2 address of the first device, or between an Internet protocol (“IP”) address of the first device and a SAM L2 address of a second device or the first device.

### FIELD OF THE INVENTION

The present invention relates generally to a method for associating addresses in a wireless system with scalable adaptive modulation (“SAM”).

### BACKGROUND OF THE INVENTION

Scalable adaptive modulation (“SAM”) is an air interface modulation that has been designed to deliver a flexible bit rate in 50, 100, and 150 kHz radio channel bandwidths primarily in the 700 MHz band. This flexibility allows SAM to optimize performance by allowing higher system data throughput under good signal conditions while still supplying significantly better throughput than current systems under weaker signal conditions. The basic mode of operation for SAM is time division multiple-access (TDMA), however, other modes may be used. The outbound transmission mode (i.e., from base station to a mobile) is continuous, while the inbound transmission mode (i.e., from a mobile to base station) is pulsed on a slot-by-slot basis. It should be understood that a mobile may transmit at the maximum available inbound slot rate. SAM reserves certain symbols within the information stream to provide for its operation. These reserved symbols are used to synchronize to the radio channel and also to provide a known reference for performing coherent demodulation of the sub-channels.

Dynamic Host Configuration Protocol (“DHCP”) services, for example, authorize hardware addresses of DHCP clients and assigns Internet protocol (“IP”) addresses to each of the DHCP clients. A DHCP server assigns the IP addresses from a pool of available IP addresses. The hardware address (or layer 2 (“L2”) address) of a DHCP client is specific to the type of L2 interface to which the DHCP client is connected; for example, a DHCP client connecting to an 802.3 link would have an 802.3 hardware L2 address, similarly, a DHCP client connecting to a SAM interface would have a SAM L2 address.

The hardware address of the DHCP client is carried in every DHCP header and is used to send the responses back to the appropriate DHCP client that requested the IP address. Essentially, the DHCP messages are addressed to the hardware L2 address of the DHCP client on the last link on which the DHCP client is located. Typically, this link is an 802.3 link—802.3 L2 employs a source and destination address for every 802.3 message. Hence, even if there are other 802.3 or 802.3-like links that are bridged, DHCP works natively over those links. However, if the message has to traverse a SAM interface before it reaches the DHCP client on another link, it works differently.

SAM L2 does not always have 802.3 source and destination addresses sent on inbound and outbound messages. The SAM L2 can rely largely upon the IP address as the identifier for information sent on inbound and outbound messages. Since the DHCP message does not always have a valid IP address, and the SAM L2 does not contain both source and destination SAM L2 addresses, DHCP cannot run natively in the system. If the source and destination 802.3 addresses are not explicitly sent inbound and outbound over SAM L2, the SAM base station and mobile station require unique functions to enable DHCP, or other similar protocols.

Thus, there exists a need for associating addresses in a wireless system with SAM.

### BRIEF DESCRIPTION OF THE FIGURES

A preferred embodiment of the invention is now described, by way of example only, with reference to the accompanying figures in which:

FIG. 1 illustrates an example of a network topology in accordance with the present invention;

FIG. 2 illustrates a message sequence flow between the various components of the network topology in accordance with the present invention;

FIG. 3 illustrates a flowchart of inbound message processing at the base station in accordance with the present invention;

FIG. 4 illustrates a flow chart of outbound message processing at the base station in accordance with the present invention; and

FIG. 5 illustrates a flowchart of outbound message processing at the mobile station in accordance with the present invention.

### DETAILED DESCRIPTION OF THE PREFERRED EMBODIMENT

While the specification concludes with claims defining the features of the present invention that are regarded as novel, it is believed that the present invention will be better understood from a consideration of the following description in conjunction with the figures, in which like reference numerals are carried forward.

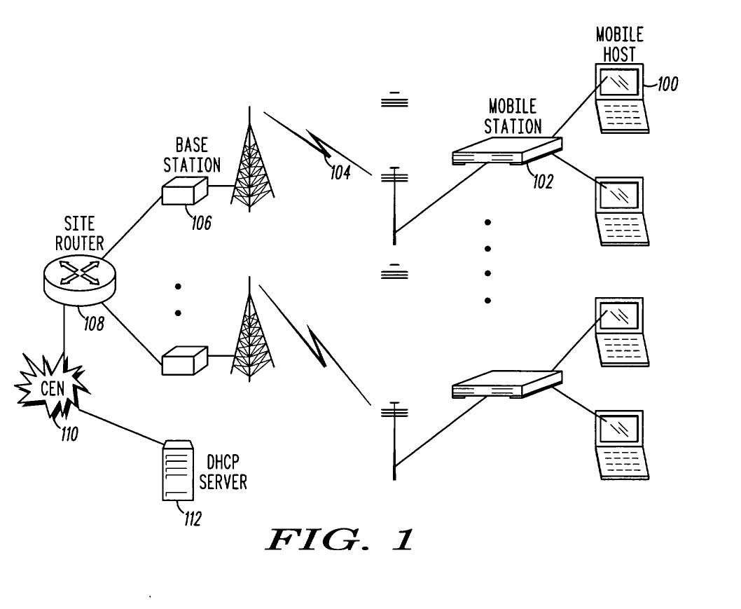

Let us first disclose a method for obtaining an Internet protocol (“IP”) address for a device over a scalable adaptive modulation (“SAM”) air interface in accordance with a preferred embodiment of the present invention, however, the method disclosed in the preferred embodiment may be applied to achieve results other than obtaining an IP address and still remain within the spirit and scope of the present invention. A mobile station and a base station allow certain protocols (e.g., dynamic host configuration protocol (“DHCP”), boot protocol (“BOOTP”), or the like) to operate transparently over the SAM interface by extracting information already present in information conveyed in the protocol layers 3-7 that would be redundantly signaled in 802.3 layer 2 (“L2”) headers. As a consequence, the present invention does not require 802.3 L2 headers to be signaled explicitly in order for these protocols to operate transparently over the SAM interface. It should be noted that reference to the various protocol layers throughout the discussion refers to the layers on the open systems interconnection (“OSI”) model. For ease of explanation, FIGS. 1-5, and associated examples, utilize DHCP, however, any suitable protocol may be used in accordance with the present invention.

FIG. 1 illustrates an example configuration of a network topology. The various components of the system may include at least one mobile host 100 (e.g., a personal digital assistant, laptop computer, or the like) coupled to a mobile station 102 (e.g., a two-way dispatch radio); the mobile host 100 is coupled to the mobile station 102 via any suitable interface, such as, PPP, Ethernet, wireless link, or the like. The mobile host 100 may be a component of the mobile station 102, wherein the mobile host 100 and the mobile station 102 exist in a single physical device. The mobile station 102 couples to a base station 106 via the SAM interface 104; the mobile station 102 further provides access to the SAM interface for the mobile host 100. In the preferred embodiment, all the base stations 106 at a site are attached to a site router 108 via any suitable connection/interface; for ease of explanation in the following examples, the present invention assumes the base station 106 is attached to the site router 108 via an Ethernet (802.3) interface. The site router 108 is coupled to a DHCP server 112 directly or via the network infrastructure to a customer enterprise network (“CEN”) 110 or other device in the network; the DHCP server 112 is responsible for allocating IP addresses to devices in the network.

It should be noted that while FIG. 1 depicts only four mobile hosts 100, two mobile stations 102, two base stations 106, one site router 108, one CEN 110 and one DHCP server 112, a practical system may include a plurality of each. For ease of explanation, it is assumed that the mobile host 100 is the device requesting the IP address from the DHCP server 112, however, any device could request an IP address for itself or another device and still remain within the spirit and scope of the present invention. Preferably, the present invention is used to obtain an IP address for the mobile host 100 on an interface other than the SAM interface through which the mobile host 100 attaches to the base station 106. Further, for purposes of the present invention, inbound messages are sent from the mobile host 100 to the DHCP server 112; outbound messages are sent from the DHCP server 112 to the mobile host 100. All inbound messages from the mobile host 100 to any device in the network will be sent at least through the mobile station 102 and the base station 106; all outbound messages from the DHCP server 112 to the mobile host 100 will be sent at least through the base station 106 and the mobile station 102.

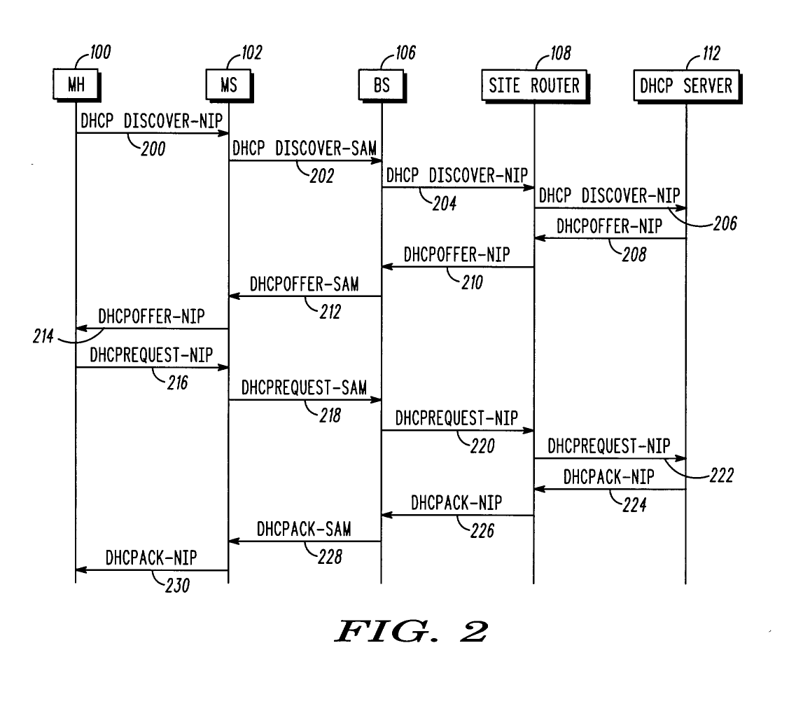

FIGS. 2-5 illustrates a message sequence flow between the various components of the system topology in accordance with the present invention. Since it is assumed that the figures and examples are based on DHCP, for ease of explanation, the following discussion of the present invention describes each DHCP message as comprising a payload and at least three headers: an IP header, a DHCP header, and a L2 header. The IP header and the DHCP header reside at L3 and L5, respectively, whereas the L2 header resides at L2; moreover, data from layers 2-7, if present, will be encapsulated by the L2 header. It should be noted, however, that even though the following discussion describes each DHCP message as comprising three separate headers, the values in the fields of the three headers might be combined or separated into any number of headers, including a single header, and still remain within the spirit and scope of the present invention.

A variety of information may be associated with any given header; only the information relevant to the present invention, however, will be discussed. For purposes of this discussion, the IP header indirectly identifies the type of the message (e.g., a DHCP message, an internet control management protocol (“ICMP”) message, etc.); the DHCP header comprises the hardware L2 address (i.e., 802.3 address) of the device that originates the message; and the L2 header identifies the type of link through which two devices are coupled (e.g., Ethernet, PPP, or the like).

In operation, as illustrated in FIG. 2, the mobile host 100 generates and broadcasts a first inbound message (typically in the form of a DHCP Discover message as known in the art) to receive an IP address (typically upon “power-on” or when its previous IP address expires) at step 200; the first inbound message comprises the IP header (indirectly identifying that the message is a DHCP message through another header, such as a user datagram protocol header), the DHCP header (identifying the hardware L2 address of the mobile host 100), and a L2 header (identifying the type of link through which the mobile host 100 is coupled to the mobile station 102).

The mobile station 102 receives the first inbound message broadcasted by the mobile host 100. Upon receipt, the mobile station 102 replaces the existing L2 header with a SAM L2 header and inserts at least a SAM L2 source address in the SAM L2 header; in the preferred embodiment, the SAM L2 source address is the SAM L2 address of the mobile station 102. At this point, the first inbound message now comprises the IP header (indirectly identifying that the message is a DHCP message), the DHCP header (identifying the hardware L2 address of the mobile host 100), and a SAM L2 header (identifying the SAM L2 address of the mobile station 102). The mobile station 102 then forwards the first inbound message over SAM 104 to the base station 106 at step 202.

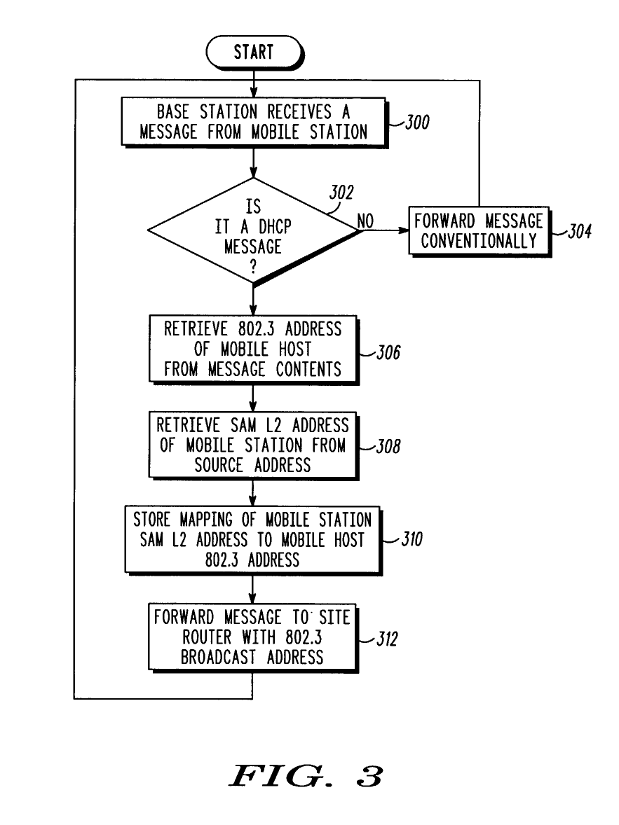

The base station 106 receives the first inbound message over SAM 104. Upon receipt, the base station 106 processes the first inbound message as outlined in FIG. 3. As illustrated in FIG. 3, when the base station 106 receives the inbound message over SAM 104 at step 300, it first determines whether the message is a DHCP message at step 302. If the inbound message is not a DHCP message, the base station 106 forwards the packets of the inbound message in a conventional manner to the site router 108 at step 304. If the inbound message, however, is a DHCP message, the base station 106 examines the DHCP header and identifies the hardware L2 address of the mobile host 100 at step 306 in accordance with the present invention. The base station 106 further examines the SAM L2 header and identifies the SAM L2 address of the mobile station 102 at step 308 in accordance with the preferred embodiment of the present invention. Once the addresses of the mobile host 100 and the mobile station 102 are identified, the base station 106 stores an association (e.g., mapping) of the SAM L2 address of the mobile station 102 with the hardware L2 address of the mobile host 100 at step 310, if not previously stored, in accordance with the present invention. This association may be a one-to-one association or a one-to-many association, since the mobile station is typically assigned to a plurality of mobile hosts in a given system. This association is advantageous because the base station 106 can identify the mobile station 102 associated with the mobile host 100. After the association is stored, the base station 106 frames the first inbound message into an 802.3 message by replacing the SAM L2 header with an 802.3 L2 header and inserting 802.3 source and destination addresses in the 802.3 L2 header; in the preferred embodiment, the 802.3 source address is the hardware L2 address of the base station 106 (alternatively, the hardware L2 address of the mobile host 100), and the 802.3 destination address is the hardware L2 address for the site router 108 (alternatively, a broadcast address). Once the appropriate addresses have been inserted in the 802.3 L2 header, the base station 106 sends the first inbound message to the site router 108 at step 312 in accordance with the present invention.

Referring back to FIG. 2, the site router 108 receives the inbound DHCP message from the base station 106; at this point, the first inbound message comprises the IP header (indirectly identifying that the message is a DHCP message), the DHCP header (identifying the hardware L2 address of the mobile host 100), and an 802.3 L2 header (identifying the hardware L2 address of base station (source) and the site router (destination)). Upon receipt, the site router 108 forwards the first inbound message to the DHCP server 112 at step 206.

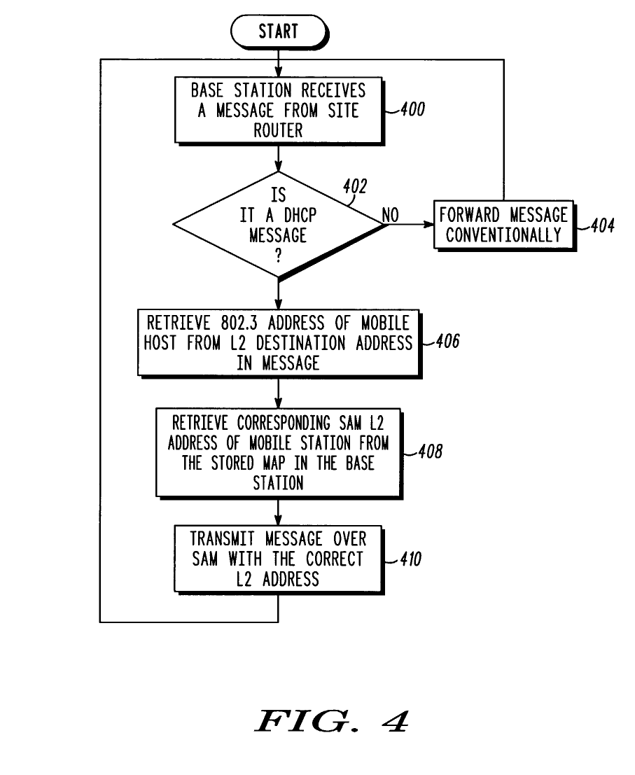

The DHCP server 112 generates and transmits a first outbound message (typically in the form of a DHCP Offer message as known in the art) in response to the first inbound message (providing an IP address that may be potentially assigned to the mobile host 100) to the site router 108 at step 208, which in turn, forwards the first outbound message to the base station 106 at step 210; at this point, the outbound message comprises the IP header (indirectly identifying that the message is a DHCP message), the DHCP header (identifying the hardware L2 address of the mobile host 100), and the 802.3 L2 header (identifying the hardware L2 address of site router (source) and the base station (destination)). Details of how the base station 106 processes the first outbound message received from the site router 108 are outlined in FIG. 4.

As illustrated in FIG. 4, when the base station 106 receives an outbound message from the site router 108 at step 400, it first determines whether the message is a DHCP message at step 402 in accordance with the present invention. If the message is not a DHCP message, the base station 106 forwards the packets of the outbound message in a conventional manner to its intended destination at step 404. If the outbound message, however, is a DHCP message, the base station 106 examines the DHCP header and identifies the hardware L2 address of the mobile host 100 at step 406 in accordance with the present invention. Since at this point the address for the mobile station 102 is not present in the outbound message, the base station 106 uses the hardware L2 address of the mobile host 100 to identify the associated SAM L2 address of the mobile station 102 from the association (map) it generated and stored at step 310 at step 408. Once the associated SAM L2 address of the mobile station 102 is identified, the base station 106 replaces the 802.3 L2 header with a SAM L2 header and inserts at least a SAM L2 destination address; in the preferred embodiment, the SAM L2 destination address is the SAM L2 address of the mobile station 102 associated with the hardware L2 address of the mobile host 100 identified in the DHCP header. The base station then transmits the outbound message over SAM 104 to the mobile station 102 identified by the SAM L2 address identified at step 408 at step 410. At this point, the outbound message comprises the IP header (indirectly identifying that the message is a DHCP message), the DHCP header (identifying the hardware L2 address of the mobile host 100), and the SAM L2 header (containing the SAM L2 address of the mobile station associated with the hardware L2 address identified in the DHCP header).

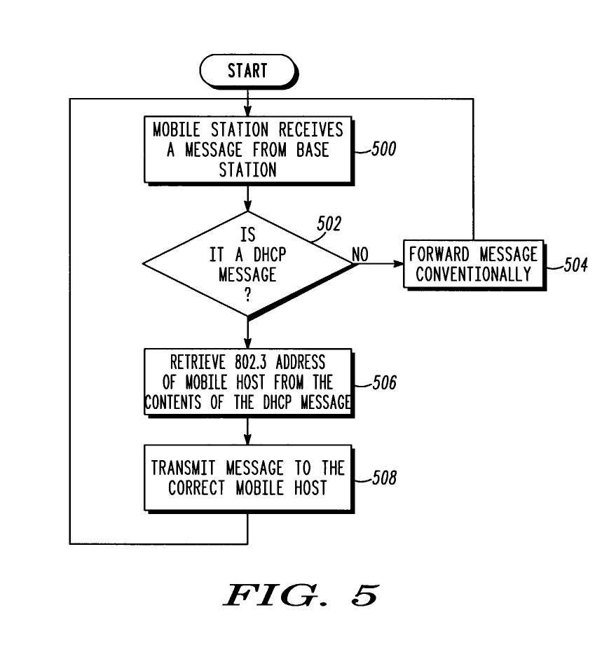

Turning now to FIG. 5, when the mobile station 102 receives the outbound message from the base station 106 at step 500 (also shown at step 212), it first determines whether the message is a DHCP message at step 502 in accordance with the present invention. If the message is not a DHCP message, the mobile station 102 forwards the packets of the message in a conventional manner to its intended destination at step 504. If the message, however, is a DHCP message, the mobile station 102 examines the DHCP header and identifies the hardware L2 address of the mobile host 100 at step 506 in accordance with the present invention. Once the hardware L2 address of the mobile host 100 is identified, the mobile station 102 replaces the SAM L2 header with a L2 header which identifies the type of link through which the mobile host 100 is connected to the mobile station 102, and transmits the outbound message to the intended mobile host 100 identified by the hardware L2 address at step 508 (also shown at step 214). At this point, the outbound message comprises the IP header (indirectly identifying that the message is a DHCP message), the DHCP header (identifying the hardware L2 address of the mobile host 100), and a L2 header (identifying the type of link through which the mobile host 100 is coupled to the mobile station 102).

Referring back to FIG. 2, the mobile host 100 may receive multiple outbound messages from multiple DHCP servers 112 at step 214. As requested, each outbound message contains a potential IP address for the mobile host 100. The outbound message also contains the IP address of the particular DHCP server 110 that sent the outbound message. The mobile host 100 chooses one of the potential IP addresses (from the plurality of outbound messages) and responds to the originator of the first outbound message with a second inbound message (typically in the form of a DHCP Request message as known in the art); the second inbound message indicates the IP address chosen by the mobile host 100.

The mobile host 100 sends the second inbound message to the mobile station 102 at step 216, which in turn, transmits the second inbound message over SAM 104 to the base station 106 at step 218. The base station 106 further sends the second inbound message to the site router 108 at step 220, which in turn sends the second inbound message to the DHCP server 112 at step 222. Upon receipt of receiving the second inbound message from the site router 108, the DHCP server 112 transmits a second outbound message (typically in the form of a DHCP ACK message as known in the art) back to the base station 106 via the site router 108 at steps 224 and 226.

Once the base station 106 receives the second outbound message from the site router 108 at step 226, the base station 106 processes the message in the same manner as described above with respect to FIG. 4. Once processed, the base station 106 transmits the second outbound message over SAM 104 to the SAM L2 address of the mobile station 102 associated with the hardware L2 address of the mobile host identified in the DHCP header of the second outbound message at step 228.

Once the mobile station 102 receives the second outbound message from the base station 106, the mobile station 102 processes the second outbound message in the same manner as described above with respect to FIG. 5. Once processed, the mobile station 102 transmits the second outbound message to the mobile host 100 identified by the hardware L2 address present in the message at step 230. The mobile host now has a valid IP address.

The individual components of the system operate on the second inbound and outbound messages in the same manner as the first inbound and outbound messages, respectively (e.g., replacing the values in the headers, etc.). It should also be noted that in the preferred embodiment, each component in the system is associated with a storage medium having stored thereon a set of instructions which, when loaded into a microprocessor, causes the microprocessor to perform the details of the present invention as described above; for example, receiving an inbound message over a SAM interface, wherein the inbound message comprises a SAM L2 header and data in which the SAM L2 header encapsulates; identifying a hardware L2 address for the first device from the encapsulated data; identifying a SAM L2 address for the second device from the SAM L2 header; and storing an association between the hardware L2 address for the first device and the SAM L2 address for the second device in a storage medium. It should be obvious to those skilled in the art, however, that the present invention may be implemented in hardware and/or software.

Let us now disclose a method for obtaining an IP address for the mobile host 100 over the SAM air interface 104 in accordance with an alternative embodiment of the present invention. The alternative embodiment of the present invention is similar to the preferred embodiment described above. For sake of brevity, the differences between the two embodiments will be outlined below.

When the mobile station 102 replaces the L2 header with the SAM L2 header, the SAM L2 source address present in the SAM L2 header is the SAM L2 address of the mobile host 100, in the alternative embodiment, not that of the mobile station 102. The mobile station 102 is aware of the respective SAM L2 addresses of the mobile hosts coupled to the mobile station 102. Thus, preferably, as in the preferred embodiment, the mobile station 102 is the device that inserts the SAM L2 address of the mobile host 100 in the SAM L2 header.

Further, in the alternative embodiment, when the base station 106 receives the first inbound message, the base station 106 stores an association between the SAM L2 address of the mobile host 100 and the hardware L2 address of the mobile host 100, assuming that the base station 106 did not store the association previously. Notwithstanding the above noted exceptions, the message flow sequence and details in the alternative embodiment is very similar to that of the preferred embodiment.

The above discussion addressed a method for obtaining an IP address for a device over the SAM air interface. Now let us focus the following discussion on transmitting IP packets inbound and outbound over the SAM air interface 104 when the device (e.g., the mobile host 100) already knows its IP address. The method of operation is very similar to the method of operation described above with the following exceptions.

In the case where the mobile host 100 already knows its IP address, the mobile station 102 will send IP packets inbound to the base station 106 with the SAM L2 source address of the mobile station 102 in the preferred embodiment. The base station 106 creates an association between the IP source address, which is L3 information, (in this case, the IP address of the mobile host 100) and the SAM L2 source address, which is L2 information, of the mobile station 102 (alternatively, the associations between the IP source addresses and the SAM L2 source address of the mobile station 102 can be explicitly signaled to the base station 106).

When inbound IP packets are sent to the site router 108, the 802.3 source address is that of the base station 106. As a result, when the site router 108 sends outbound messages, the site router 108 uses the 802.3 destination address of base station 106 and the IP address of the mobile host 100. When the base station 106 receives the outbound message, the base station 106 replaces the 802.3 L2 header containing the 802.3 destination address with a SAM L2 header comprising the SAM L2 address of the mobile station 102 associated with the IP address of the mobile host 100 in accordance with the preferred embodiment of the present invention.

In the alternative embodiment, the mobile station 102 sends IP packets inbound to the base station 106 with the SAM L2 source address of the mobile host 100. The base station 106 creates an association between the hardware L2 address of the mobile host 100 and the SAM L2 source address of the mobile host 100 via an address resolution protocol (“ARP”) or any other suitable protocol that creates associations between hardware L2 addresses and IP addresses (alternatively, the associations between the hardware L2 addresses of the mobile hosts and the SAM L2 addresses of the mobile hosts can be negotiated between the mobile station 102 and the base station 106). When the IP packets are sent inbound to the site router 108, the 802.3 source address is that of the mobile host 100. When the site router 108 sends outbound messages, it uses the hardware L2 address of mobile host 100 and the IP address of the mobile host 100. When the base station 106 receives the outbound message, it replaces the 802.3 L2 header containing the hardware L2 address of the mobile host 100 with a SAM L2 header comprising the SAM L2 address of the mobile host 100 associated with the hardware L2 address of the mobile host 100.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. For example, any device (e.g., the mobile host, the mobile station, etc.) could request an IP address for itself; a second device (e.g., the mobile station, a third device, etc.) could request an IP address for or on behalf of the first device (e.g., the mobile host), etc. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

We claim:

1. A method comprising the steps of:
receiving an inbound message over a scalable adaptive modulation (“SAM”) interface, wherein the inbound message comprises a SAM layer 2 (“L2”) header and data in which the SAM L2 header encapsulates;
identifying a hardware L2 address of a first device from the encapsulated data;
identifying a SAM L2 address of a second device from the SAM L2 header; and
storing an association between the hardware L2 address of the first device and the SAM L2 address of the second device in a storage medium.

2. The method of claim 1 wherein the encapsulated data is at least one of a dynamic host configuration protocol (“DHCP”) message and a boot protocol (“BOOTP”) message.

3. The method of claim 1 wherein the encapsulated data resides in at least one of layer 2, layer 3, layer 4, layer 5, layer 6, and layer 7.

4. The method of claim 1 wherein the inbound message requests an Internet protocol address for the first device.

5. The method of claim 1 wherein the inbound message originated from one of the following device: the first device, the second device, and a third device.

6. The method of claim 1 further comprising the step of continually performing both steps of identifying, and the step of storing each time a new inbound message is received.

7. The method of claim 1 further comprising the step of:
receiving an outbound message destined for a first device;
identifying a hardware L2 address of the first device from the outbound message;
identifying a SAM L2 address of a second device from the storage medium, wherein the SAM L2 address is associated with the hardware L2 address identified from the outbound message; and
transmitting the outbound message to the first device over the SAM interface via the SAM L2 address of the second device associated with the first device.

8. The method of claim 1 wherein the step of storing comprises the step of generating a one-to-one association between the hardware L2 address of the first device and the SAM L2 address of the second device.

9. The method of claim 1 wherein the step of storing comprises the step of generating a one-to-many association between the SAM L2 address of the second device and the hardware L2 addresses of a plurality of first devices.

10. The method of claim 1 further comprising the step of transmitting the inbound message to its intended destination with the hardware L2 address of the first device.

11. A method comprising the steps of:
receiving an inbound message over a scalable adaptive modulation (“SAM”) interface, wherein the inbound message comprises a SAM layer 2 (“L2”) header and data in which the SAM L2 header encapsulates;
identifying a hardware L2 address of a first device from the encapsulated data;
identifying a SAM L2 address of the first device from the SAM L2 header; and
storing an association between the hardware L2 address of the first device and the SAM L2 address of the first device in a storage medium.

12. The method of claim 11 wherein the encapsulated data is one of a dynamic host configuration protocol (“DHCP”) message and a boot protocol (“BOOTP”) message.

13. The method of claim 11 further comprising the step of:
receiving an outbound message destined for a first device;
identifying a hardware L2 address of the first device from the outbound message;
identifying a SAM L2 address of the first device from the storage medium, wherein the SAM L2 address is associated with the hardware L2 address identified from the outbound message; and
transmitting the outbound message to the first device via the SAM L2 address.

14. A method comprising the steps of:
receiving an inbound message over a scalable adaptive modulation (“SAM”) interface, wherein the inbound message comprises a SAM layer 2 (“L2”) header and data in which the SAM L2 header encapsulates;
identifying a Internet protocol (“IP”) address of the first device from the encapsulated data;
identifying a SAM L2 address of the second device from the SAM L2 header; and
storing an association between the IP address of the first device and the SAM L2 address of the second device in a storage medium.

15. The method of claim 14 further comprising the step of continually performing both steps of identifying, and the step of storing each time a new inbound message is received.

16. The method of claim 14 further comprising the step of:
receiving an outbound message destined for a first device;
identifying a IP address of the first device from the outbound message;
identifying a SAM L2 address of a second device from the storage medium, wherein the SAM L2 address is associated with the IP address identified from the outbound message; and
transmitting the outbound message to the first device over the SAM interface via the SAM L2 address of the second device associated with the first device.

17. The method of claim 14 wherein the step of storing comprises the step of generating a one-to-one association between the IP address of the first device and the SAM L2 address of the second device.

18. The method of claim 14 wherein the step of storing comprises the step of generating a one-to-many association between the SAM L2 address of the second device and the IP addresses of a plurality of first devices.

19. A method comprising the steps of:
receiving an inbound message over a scalable adaptive modulation (“SAM”) interface, wherein the inbound message comprises SAM layer 2 (“L2”) header and data in which the SAM L2 header encapsulates;
identifying a Internet protocol (“IP”) address of the first device from the encapsulated data;
identifying a SAM L2 address of the first device from the SAM L2 header; and
storing an association between the IP address of the first device and the SAM L2 address of the first device in a storage medium.

20. The method of claim 19 further comprising the step of:
receiving an outbound message destined for a first device;
identifying a IP address of the first device from the outbound message;
identifying a SAM L2 address of the first device from the storage medium, wherein the SAM L2 address is associated with the IP address identified from the outbound message; and
transmitting the outbound message to the first device via the SAM L2 address.
